(19) United States
(12) Patent Application Publication
(10) Pub. No.: US 2013/0149791 A1
(43) Pub. Date: Jun. 13, 2013

(54) BIOCHIPS AND METHODS FOR INJECTING A SPECIFIC MICROVOLUME OF SAMPLE

(71) Applicant: Electronics and Telecommunications Research In, Daejeon (KR)

(72) Inventors: Jongcheol HONG, Daejeon (KR); Gun Yong SUNG, Daejeon (KR); Seunghwan KIM, Daejeon (KR)

(73) Assignee: Electronics and Telecommunications Research Institute, Daejeon (KR)

(21) Appl. No.: 13/653,351

(22) Filed: Oct. 16, 2012

(30) Foreign Application Priority Data
Dec. 9, 2011 (KR) 10-2011-0132072

(51) Int. Cl. B01L 3/00; G01N 1/28

(52) U.S. Cl. 436/180; 422/503

(57) ABSTRACT

A biochip is provided. The biochip may include a reaction chamber containing a reagent, an injection channel including a sample injection channel to inject the sample into the reaction chamber and a sample bypass channel preventing the sample from being injected into the reaction chamber, and an exhaust channel connected to both of the sample exhaust channel and the sample bypass channel.

### CROSS-REFERENCE TO RELATED APPLICATIONS

This U.S. non-provisional patent application claims priority under 35 U.S.C. §119 to Korean Patent Application No. 10-2011-0132072, filed on Dec. 9, 2011, in the Korean Intellectual Property Office, the entire contents of which are hereby incorporated by reference.

### BACKGROUND OF THE INVENTION

Embodiments of the inventive concepts relate to a biochip, and in particular, biochips and methods for injecting a specific volume of a sample.

There have been diagnostic chips to diagnose a patient's condition on site in a short time or to enhance point-of-care testing (POCT). In the diagnostic chips, blood and urine may be used to detect and quantify a biomarker identifying a specific disease. To avoid an operator's intervention and reduce an amount of sample, extensive researches have been conducted to develop a micro-fluid control device in the form of biochip.

For a biochip or cartridge using a micro volume of fluid, an external pump may be used to transport the fluid (for example, into a reaction chamber). Alternatively, the fluid may be transported by an internal pumping structure provided in the micro-fluid control device.

In the case where a concentration of a target material contained in a sample is measured by a reagent provided in a biochip to identify the target material, a ratio in amount between the sample and the reagent should be controlled to be a desired value.

Accordingly, the external pump or the internal pumping structure should be configured to be able to control exactly an amount of the sample. For example, they should be configured to have a sophisticated structure or include additionally an external pumping controller. In the view of point-of-care testing, the need for the sophisticated or external amount-control device makes it difficult for the biochip to have a reduced size and a reduced fabrication cost.

### SUMMARY

Embodiments of the inventive concepts provide a biochip configured to be able to inject a specific volume of sample into a reaction chamber.

Other example embodiments of the inventive concept provide a method of injecting a specific volume of sample into a reaction chamber.

According to example embodiments of the inventive concepts, a biochip may include a reaction chamber containing a reagent to detect a sample, an injection channel including a sample injection channel to inject the sample into the reaction chamber and a sample bypass channel to be used not to inject the sample into the reaction chamber, and an exhaust channel connected to both of the sample exhaust channel, which may be used to exhaust the sample from the reaction chamber, and the sample bypass channel.

In example embodiments, the injection channel may have a structure, branching out into the sample injection channel and the sample bypass channel, in front of the reaction chamber. A non-branching portion of the injection channel has a width greater than that of the sample injection channel or the sample bypass channel.

In example embodiments, the sample injection channel has the same width and height as the sample bypass channel.

In example embodiments, the sample exhaust channel has the same width and height as the sample injection channel.

In example embodiments, the exhaust channel has the same width and height as the sample exhaust channel.

In example embodiments, the biochip may further include an inlet connected to the injection channel and used to inject the sample into the injection channel.

In example embodiments, the biochip may further include an outlet connected to the exhaust channel and used to exhaust the sample from the exhaust channel.

According to example embodiments of the inventive concepts, a biochip may include an inlet for injecting a sample, a reaction chamber containing a reagent to detect the sample, a sample injection channel connected to the inlet to inject the sample into the reaction chamber, a sample bypass channel connected to the inlet, the sample bypass channel being separated from the sample injection channel to prevent the sample from being injected into the reaction chamber, a sample exhaust channel connected to the sample bypass channel to exhaust the sample from the reaction chamber, an exhaust channel connected to both of the sample bypass channel and the sample exhaust channel, and an outlet connected to the exhaust channel and used to exhaust the sample from the exhaust channel.

In example embodiments, the sample injection channel has the same width and height as the sample bypass channel.

In example embodiments, the sample exhaust channel has the same width and height as the sample injection channel.

In example embodiments, the exhaust channel has the same width and height as the sample exhaust channel.

According to example embodiments of the inventive concepts, a method of injecting a specific volume of sample may include injecting a portion of a sample into a reaction chamber through a sample injection channel, the other portion of the sample being detoured around the reaction chamber along a sample bypass channel, blocking a sample exhaust channel connected to the reaction chamber with the other portion of the sample detoured along the sample bypass channel, and exhausting the sample by using an inflowing air supplied through the sample bypass channel.

In example embodiments, the sample injection channel and the sample bypass channel may be combined with each other in front of the reaction chamber to form a single channel.

In example embodiments, the sample injection channel and the sample bypass channel may be separated from each other.

In example embodiments, the sample injection channel has the same width and height as the sample bypass channel.

In example embodiments, the sample exhaust channel has the same width and height as the sample injection channel.

### BRIEF DESCRIPTION OF THE DRAWINGS

Example embodiments will be more clearly understood from the following brief description taken in conjunction with the accompanying drawings. The accompanying drawings represent non-limiting, example embodiments as described herein.

FIG. 1 is a schematic plan view of a biochip according to example embodiments of the inventive concept;

FIGS. 2A through 2E are schematic plan views illustrating a method of injecting a specific volume of sample according to example embodiments of the inventive concept and showing a portion A of FIG. 1; and

FIG. 3 is a schematic plan view of a biochip according to other example embodiments of the inventive concept.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION

Example embodiments of the inventive concepts will now be described more fully with reference to the accompanying drawings, in which example embodiments are shown. Example embodiments of the inventive concepts may, however, be embodied in many different forms and should not be construed as being limited to the embodiments set forth herein; rather, these embodiments are provided so that this disclosure will be thorough and complete, and will fully convey the concept of example embodiments to those of ordinary skill in the art. In the drawings, the thicknesses of layers and regions are exaggerated for clarity. Like reference numerals in the drawings denote like elements, and thus their description will be omitted.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Like numbers indicate like elements throughout. As used herein the term “and/or” includes any and all combinations of one or more of the associated listed items. Other words used to describe the relationship between elements or layers should be interpreted in a like fashion (e.g., “between” versus “directly between,” “adjacent” versus “directly adjacent,” “on” versus “directly on”).

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof.

Example embodiments of the inventive concepts are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments of the inventive concepts should not be construed as limited to the particular shapes of regions illustrated herein but are to include deviations in shapes that result, for example, from manufacturing. For example, an implanted region illustrated as a rectangle may have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments of the inventive concepts belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

FIG. 1 is a schematic plan view of a biochip according to example embodiments of the inventive concept.

Referring to FIG. 1, a biochip 100 may include an inlet 110, a reaction chamber 114, an injection channel 112, an exhaust channel 116, and an outlet 120. The inlet 110 may be used to inject a sample, and the reaction chamber 114 may be configured to contain a reagent for detecting the sample. The injection channel 112 may include a sample injection channel 112i, a sample bypass channel 112d, and a sample exhaust channel 112o. The sample injection channel 112i may be used to deliver the sample to the reaction chamber 114, and the sample bypass channel 112d may provide a detour path preventing the sample from being injected into the reaction chamber 114. The sample exhaust channel 112o may be connected to a side of the reaction chamber 114 opposite the sample injection channel 112i and be used to exhaust the sample from the reaction chamber 114. The exhaust channel 116 may be connected to both of the sample bypass channel 112d and the sample exhaust channel 112o. The outlet 120 may be connected to the exhaust channel 116 to exhaust the sample.

In example embodiments, the reagent for detecting the sample may be provided within the reaction chamber 114, in advance, by using a drying or freeze-drying method. However, example embodiments of the inventive concepts may not be limited thereto, and for example, various methods may be used to provide or supply the reagent into the reaction chamber 114.

In other embodiments, the biochip 100 may be configured to include a plurality of reaction chambers 114. In this case, each of the reaction chambers 114 may be configured to include the sample injection channel 112i, the sample bypass channel 112d and sample exhaust channel 112o. This enables to perform analyses on various target materials included in the sample at the same time.

The biochip 100 may include a body formed of silicon, glass, plastic polymer, or any combination thereof. The injection channel 112, the sample injection channel 112i, the sample bypass channel 112d, the reaction chamber 114, the sample exhaust channel 112o, and the exhaust channel 116 may be provided to define a fluid channel structure (i.e., a pathway formed in the body to have predetermined widths and predetermined heights). The inlet 110 and the outlet 120 may be holes formed in the body and connected to the injection channel 112 and the exhaust channel 116, respectively.

The injection channel 112 may be formed to have a structure branching out into the sample injection channel 112i and the sample bypass channel 112d, between the inlet 110 and the reaction chamber 114. Accordingly, a non-branching portion of the injection channel 112 may have a width greater than that of the sample injection channel 112i or the sample bypass channel 112d. In example embodiments, the sample injection channel 112i may have the same width and height as the sample bypass channel 112d.

The sample exhaust channel 112o may have the same width and height as the sample injection channel 112i. The exhaust channel 116 may have the same width and height as the sample exhaust channel 112o.

According to example embodiments of the inventive concept, the biochip 100 may be configured to include the sample bypass channel 112d, instead of an external pumping controller. As a result, it is possible to simplify an overall process of fabricating the biochip 100. For example, the biochip 100 can be fabricated by changing merely a design thereof, without adding a fabrication process. In other words, the sample bypass channel 112d may be easily and simply formed by a simple method, such as an injection or extrusion molding, during the process of fabricating the biochip 100.

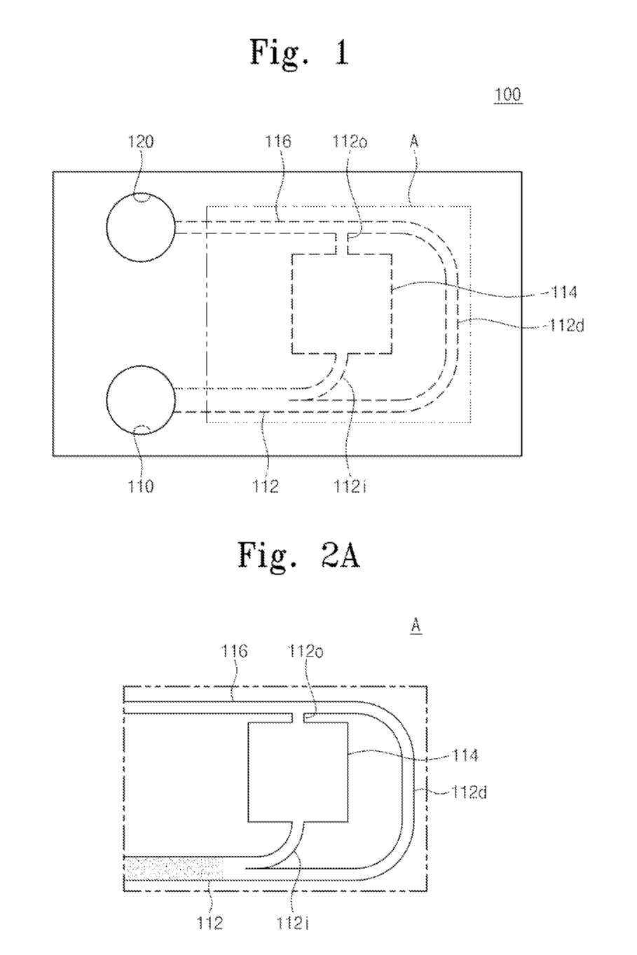

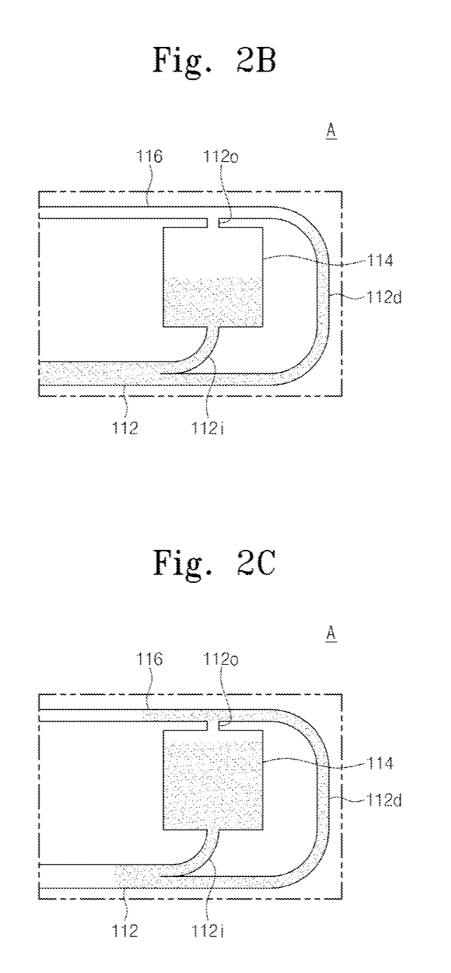

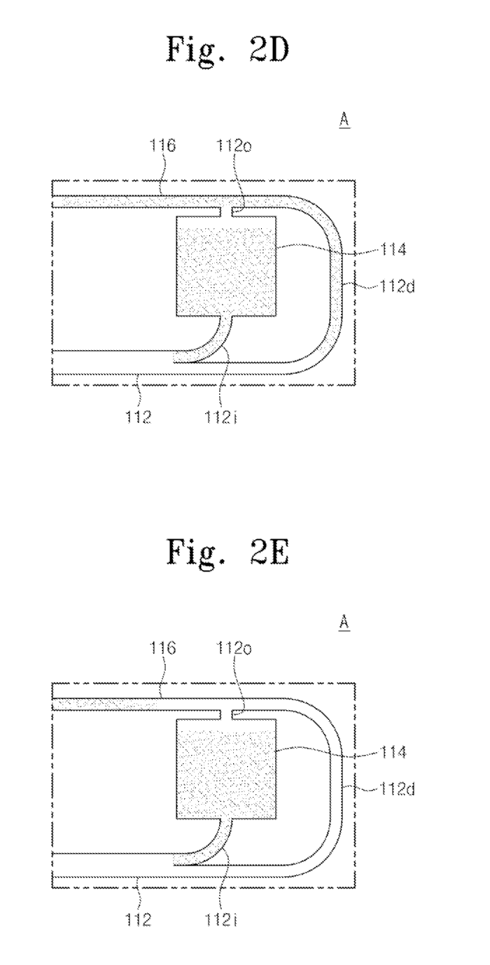

FIGS. 2A through 2E are schematic plan views illustrating a method of injecting a specific volume of sample according to example embodiments of the inventive concept and showing a portion A of FIG. 1.

Referring to FIGS. 2A and 2B, a sample solution (depicted by a sandy pattern) may be injected through the injection channel 112. The injection channel 112 may branch out into the sample injection channel 112i and the sample bypass channel 112d, in front of the reaction chamber 114. Accordingly, a part of the sample solution injected into the injection channel 112 may be injected into the reaction chamber 114 through the sample injection channel 112i, and the other of the sample solution may be detoured around the reaction chamber 114 along the sample bypass channel 112d.

Referring to FIG. 2C, in the case where the other of the sample solution detoured along the sample bypass channel 112d arrives at the sample exhaust channel 112o, the reaction chamber 114 may be disconnected from the exhaust channel 116. Accordingly, there is no more sample solution injecting into the reaction chamber 114 and the sample injection channel 112i.

Referring to FIGS. 2D and 2E, if the injection of the sample solution into the injection channel 112 is completed, an inflowing air may flow into only the sample bypass channel 112d by a difference in flow resistance between the sample injection channel 112i and the sample bypass channel 112d. The air moving along the sample bypass channel 112d may be used to exhaust the sample solution from the sample bypass channel 112d and the exhaust channel 116.

As the result of the operation, a specific volume of a sample solution can be injected into the reaction chamber 114. In other words, a volume of the sample solution to be injected into the reaction chamber 114 may be controlled by changing factors, such as the difference in flow resistance between the sample injection channel 112i and the sample bypass channel 112d or a length of the sample bypass channel 112d. That is, a method of injecting a specific volume of sample according to example embodiments of the inventive concept can be realized by the biochip 100.

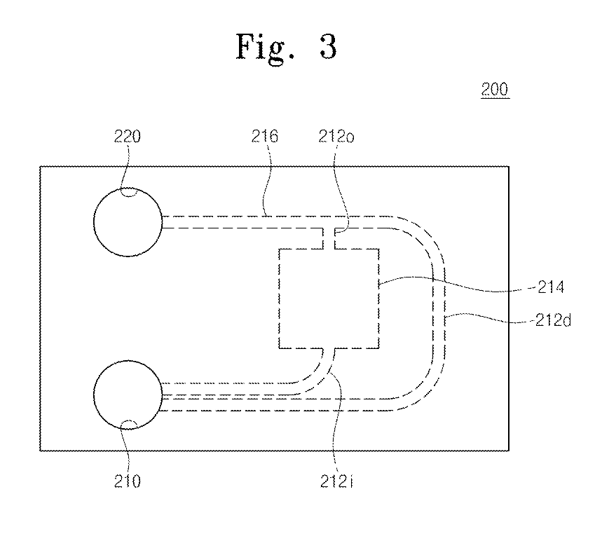

FIG. 3 is a schematic plan view of a biochip according to other example embodiments of the inventive concept.

Referring to FIG. 3, a biochip 200 may include an inlet 210, a reaction chamber 214, a sample injection channel 212i, a sample bypass channel 212d, a sample exhaust channel 212o, an exhaust channel 216, and an outlet 220. The inlet 210 may be used to inject a sample, and the reaction chamber 214 may be configured to contain a reagent for detecting the sample. The sample injection channel 212i may be used to deliver the sample to the reaction chamber 214, and the sample bypass channel 212d may provide a detour path preventing the sample from being injected into the reaction chamber 214. The sample exhaust channel 212o may be connected to a side of the reaction chamber 214 opposite the sample injection channel 212i and be used to exhaust the sample from the reaction chamber 214. The exhaust channel 216 may be connected to both of the sample bypass channel 212d and the sample exhaust channel 212o. The outlet 220 may be connected to the exhaust channel 216 to exhaust the sample.

In example embodiments, the reagent for detecting the sample may be provided within the reaction chamber 214, in advance, by using a drying or freeze-drying method. However, example embodiments of the inventive concepts may not be limited thereto, and for example, various methods may be used to provide or supply the reagent into the reaction chamber 214.

In other embodiments, the biochip 200 may be configured to include a plurality of reaction chambers 214. In this case, each of the reaction chambers 214 may be configured to include the sample injection channel 212i, the sample bypass channel 212d and sample exhaust channel 212o. This enables to perform analyses on various target materials included in the sample at the same time.

The biochip 200 may include a body formed of silicon, glass, plastic polymer, or any combination thereof. The sample injection channel 212i, the sample bypass channel 212d, the reaction chamber 214, the sample exhaust channel 212o, and the exhaust channel 216 may be provided to define a fluid channel structure (i.e., a pathway formed in the body to have predetermined widths and predetermined heights). The inlet 210 may be a hole that is formed in the body and connected to the ample injection channel 212i and the sample bypass channel 212d spaced apart from each other, and the outlet 220 may be a hole that is formed in the body and be connected to the exhaust channel 216.

The sample injection channel 212i may have the same width and height as the sample bypass channel 212d. The sample exhaust channel 212o may have the same width and height as the sample injection channel 212i. The exhaust channel 216 may have the same width and height as the sample exhaust channel 212o.

According to other example embodiments of the inventive concept, the biochip 200 may be configured to include the sample bypass channel 212d, instead of an external pumping controller. As a result, it is possible to simplify an overall process of fabricating the biochip 200. For example, the biochip 200 can be fabricated by changing merely a design thereof, without adding a fabrication process. In other words, the sample bypass channel 212d may be easily and simply formed by a simple method, such as an injection or extrusion molding, during the process of fabricating the biochip 200.

In the biochips according to example embodiments of the inventive concept, a simple fluid channel structure may be used to inject a specific volume of a sample solution, instead of an external pumping controller. Accordingly, it is possible to realize biochips and methods capable of injecting a specific volume of sample.

In addition, in the case of the biochips with the fluid channel structure, since a specific volume of the sample can be injected into the reaction chamber, readers for the biochip can have a simplified structure. This enables to provide a diagnostic kit including an inexpensive and small-sized biochip and a diagnostic method using the same.

While example embodiments of the inventive concepts have been particularly shown and described, it will be understood by one of ordinary skill in the art that variations in form and detail may be made therein without departing from the spirit and scope of the attached claims.

What is claimed is:

1. A biochip, comprising:
a reaction chamber containing a reagent to detect a sample;
an injection channel including a sample injection channel to inject the sample into the reaction chamber and a sample bypass channel preventing the sample from being injected into the reaction chamber; and
an exhaust channel connected to both of the sample exhaust channel, which is used to exhaust the sample from the reaction chamber, and the sample bypass channel.

2. The biochip of claim 1, wherein the injection channel has a structure, branching out into the sample injection channel and the sample bypass channel, in front of the reaction chamber.

3. The biochip of claim 2, wherein a non-branching portion of the injection channel has a width greater than that of the sample injection channel or the sample bypass channel.

4. The biochip of claim 1, wherein the sample injection channel has the same width and height as the sample bypass channel.

5. The biochip of claim 1, wherein the sample exhaust channel has the same width and height as the sample injection channel.

6. The biochip of claim 1, wherein the exhaust channel has the same width and height as the sample exhaust channel.

7. The biochip of claim 1, further comprising, an inlet connected to the injection channel and used to inject the sample into the injection channel.

8. The biochip of claim 1, further comprising, an outlet connected to the exhaust channel and used to exhaust the sample from the exhaust channel.

9. A biochip, comprising:
an inlet for injecting a sample;
a reaction chamber containing a reagent to detect the sample;
a sample injection channel connected to the inlet to inject the sample into the reaction chamber;
a sample bypass channel connected to the inlet, the sample bypass channel being separated from the sample injection channel to prevent the sample from being injected into the reaction chamber;
a sample exhaust channel connected to the sample bypass channel to exhaust the sample from the reaction chamber;
an exhaust channel connected to both of the sample bypass channel and the sample exhaust channel; and
an outlet connected to the exhaust channel to exhaust the sample from the exhaust channel.

10. The biochip of claim 9, wherein the sample injection channel has the same width and height as the sample bypass channel.

11. The biochip of claim 9, wherein the sample exhaust channel has the same width and height as the sample injection channel.

12. The biochip of claim 9, wherein the exhaust channel has the same width and height as the sample exhaust channel.

13. A method of injecting a specific volume of sample, comprising:
injecting a portion of a sample into a reaction chamber through a sample injection channel, the other portion of the sample being detoured around the reaction chamber along a sample bypass channel;
blocking a sample exhaust channel connected to the reaction chamber with the other portion of the sample detoured along the sample bypass channel; and
exhausting the sample by using an inflowing air supplied through the sample bypass channel.

14. The method of claim 13, wherein the sample injection channel and the sample bypass channel are combined with each other in front of the reaction chamber to form a single channel.

15. The method of claim 13, wherein the sample injection channel and the sample bypass channel are separated from each other.

16. The method of claim 13, wherein the sample injection channel has the same width and height as the sample bypass channel.

17. The method of claim 13, wherein the sample exhaust channel has the same width and height as the sample injection channel.
